(19) United States
(12) Patent Application Publication
(10) Pub. No.: US 2012/0180086 A1
(43) Pub. Date: Jul. 12, 2012

(54) TERRESTRIAL/ SATELLITE SET-TOP-BOX SYSTEM WITH DOCKING STATION

(75) Inventor: Chao-Tung Yang, Hsinchu (TW)

(73) Assignee: LINGO LIMITED, Kowloon (HK)

(21) Appl. No.: 13/346,732

(22) Filed: Jan. 10, 2012

(30) Foreign Application Priority Data
Jan. 10, 2011 (TW) 100200520

(51) Int. Cl. G06F 13/00; H04N 21/40

(52) U.S. Cl. 725/37

(57) ABSTRACT

A terrestrial/satellite set-top-box (STB) system is provided. The system includes a handheld device and an STB. The handheld device has a built-in interactive application program. The STB includes a docking station and a playing circuit. The docking station carries the handheld device. The handheld device can be used for setting or remotely controlling the STB. The STB is linked to a wireless network via the handheld device so as to play movies and news programs from the network. The invention can solve the disadvantage of failing wirelessly to link network in the prior art.

### CROSS-REFERENCE TO RELATED APPLICATION

This application claims the priority benefit of Taiwan application serial no. 100200520, filed on Jan. 10, 2011. The entirety of the above-mentioned patent application is hereby incorporated by reference herein and made a part of this specification.

### BACKGROUND

1. Field of the Utility Model

The present invention generally relates to a terrestrial/satellite set-top-box (STB) system with a docking station.

2. Description of Related Art

A common screen such as monitor or cathode ray tube (CRT) does not have television (TV) or digital TV functions. If a user wants to use a common screen watching TV, it is needed to purchase an STB with TV function for operation.

Currently, a vendible STB can support cable network, but not wireless network. In order to use such kind of STB, the user needs to pay an additional fee to a cable service provider, which is a burden for the user.

In addition, the vendible STB is unable to play movies or browse photos in a handheld device.

### SUMMARY OF THE DISCLOSURE

In order to overcome the above-mentioned shortage, the present invention provides a terrestrial/satellite STB system, which includes a handheld device and an STB. The handheld device has a built-in interactive application program. The STB includes: a docking station for carrying the handheld device; and a playing circuit coupled to the docking station for outputting an audio/video signal (AV signal) to outside for playing. The above-mentioned STB is a receiving box of any broadcasting signal, cable terrestrial signal or satellite signal. When the handheld device is placed into the docking station of the STB so as to start the interactive application program, the handheld device displays an interactive graphical user interface for guiding a user to set the STB.

The invention further provides a terrestrial/satellite STB system, which includes a handheld device and an STB. The handheld device has a built-in interactive application program. The STB includes: a docking station for carrying the handheld device; a communication receiver for receiving wireless command and data emitted from the handheld device; a playing circuit coupled to the communication receiver and the docking station for outputting an AV signal to outside for playing. The above-mentioned STB is a receiving box of any broadcasting signal, cable terrestrial signal or satellite signal. When a user uses the handheld device to start the interactive application program, the handheld device emits a control signal wirelessly transmitted to the communication receiver and the handheld device displays an interactive graphical user interface for guiding the user to set the STB.

In an embodiment of the present invention, the above-mentioned playing circuit is coupled to the handheld device via the docking station and the playing circuit plays the data transmitted from the handheld device.

In an embodiment of the present invention, the above-mentioned handheld device is linked to a wireless network and transfers the data of the wireless network to the STB for playing.

In an embodiment of the present invention, the above-mentioned handheld device is linked to the wireless network via 3G mobile communication protocol or global communication system protocol.

In an embodiment of the present invention, the above-mentioned STB further includes a charging circuit coupled to the docking station. When the handheld device is placed into the docking station of the STB, the charging circuit charges the handheld device.

In an embodiment of the present invention, the above-mentioned STB further includes an analog antenna port coupled to the playing circuit for receiving an analog video signal, wherein the playing circuit is for converting and playing the analog video signal.

In an embodiment of the present invention, the above-mentioned STB further includes a digital antenna port coupled to the playing circuit for receiving a digital video signal, wherein the playing circuit is for converting and playing the digital video signal.

In an embodiment of the present invention, the above-mentioned STB further includes an audio/video (AV) input port, an high-definition (HD) multimedia input port or a video graphics array (VGA) input port, wherein the audio/video input port, the high-definition multimedia input port or the VGA input port is coupled to the playing circuit, and the playing circuit is for converting and playing the signals transmitted from the above-mentioned input ports.

In an embodiment of the present invention, the above-mentioned STB further includes an image output port and an audio output port, wherein the image output port is coupled to the output of the playing circuit for outputting an image signal, and the audio output port is coupled to the output of the playing circuit for outputting an audio signal.

In an embodiment of the present invention, the above-mentioned handheld device is one of smart mobile phone, personal digital assistant (PDA) and portable digital multimedia player.

In an embodiment of the present invention, the above-mentioned STB further includes a display screen, wherein the playing circuit outputs a menu to the display screen for the user to set the STB.

In an embodiment of the above invention, after starting the interactive application program, the handheld device serves as a remote controller of the STB.

In an embodiment of the present invention, the above-mentioned handheld device is for setting source of a played signal, television channel and audio volume of the STB.

In an embodiment of the present invention, the wireless transmission method between the handheld device and the STB is one of infrared protocol, 3G (third generation) mobile communication protocol, bluetooth protocol and Wi-Fi protocol.

In an embodiment of the present invention, the above-mentioned handheld device wirelessly transmits data to the STB for playing.

In an embodiment of the present invention, the above-mentioned STB feeds received information associated with the radio names, video, or electronic program guide back to the handheld device via wireless transmission.

The invention further provides a terrestrial/satellite STB system, including: a first handheld device, a second handheld device and an STB. The first handheld device has a built-in interactive application program. The STB includes: a first docking station for carrying the handheld device; a second docking station for carrying the second handheld device; and a playing circuit coupled to the first docking station and the second docking station for outputting an audio/video signal to outside for playing. The STB herein is a receiving box of any broadcasting signal, cable terrestrial signal or satellite signal. When the first handheld device is placed into the first docking station of the STB to start the interactive application program, the first handheld device displays an interactive graphical user interface for guiding a user to set the STB.

The invention further provides a terrestrial/satellite STB system, which includes a first handheld device, a second handheld device and an STB. The first handheld device has a built-in interactive application program. The STB includes: a first docking station for carrying the first handheld device; a second docking station for carrying the second handheld device; a communication receiver for receiving the wireless command and data emitted from the first handheld device; and a playing circuit coupled to the communication receiver, the first docking station and the second docking station for outputting an audio/video signal to outside for playing. When a user uses the first handheld device to start the interactive application program, the first handheld device emits a control signal wirelessly transmitted to the communication receiver and the first handheld device displays an interactive graphical user interface for guiding the user to set the STB.

In an embodiment of the present invention, the above-mentioned playing circuit is coupled to the first handheld device via the first docking station and the playing circuit plays the data transmitted from the first handheld device.

In an embodiment of the present invention, the above-mentioned second handheld device is placed into the second docking station of the STB, the playing circuit is coupled to the second handheld device via the second docking station and the playing circuit plays the data transmitted from the second handheld device.

In an embodiment of the above invention, after starting the interactive application program, the first handheld device serves as a remote controller of the STB.

In an embodiment of the present invention, the above-mentioned second handheld device is placed into the second docking station of the STB, the playing circuit is coupled to the second handheld device via the second docking station and the playing circuit plays the data transmitted from the second handheld device.

In an embodiment of the present invention, the above-mentioned second handheld device is linked to a wireless network and transfers the data of the wireless network to the STB for playing.

In an embodiment of the present invention, the above-mentioned second handheld device is linked to the wireless network via 3G mobile communication protocol or global communication system protocol.

In an embodiment of the present invention, the above-mentioned first handheld device is for setting source of a played signal, television channel and audio volume of the STB.

In an embodiment of the above invention, the wireless transmission method between the first handheld device and the STB is one of infrared protocol, 3G mobile communication protocol, bluetooth protocol and Wi-Fi protocol.

In an embodiment of the present invention, the above-mentioned first handheld device wirelessly transmits data to the STB for playing.

In an embodiment of the present invention, the above-mentioned first handheld device is linked to a wireless network and transfers the data of the wireless network to the STB for playing.

In an embodiment of the present invention, the above-mentioned STB feeds received information associated with the radio names, video, or electronic program guide back to the first handheld device via wireless transmission.

In an embodiment of the present invention, the above-mentioned first handheld device is linked to the wireless network via 3G mobile communication protocol or global communication system protocol.

In order to make the aforementioned and other features and advantages of the invention comprehensible, several exemplary embodiments accompanied with figures are described in detail below.

### BRIEF DESCRIPTION OF THE DRAWINGS

FIG. 1 is a diagram of a terrestrial/satellite STB system according to an embodiment of the invention.

FIG. 2 is a diagram of a terrestrial/satellite STB system according to another embodiment of the invention.

FIG. 3 is a diagram of a terrestrial/satellite STB system according to yet another embodiment of the invention.

FIG. 4 is a diagram of a terrestrial/satellite STB system according to yet another embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

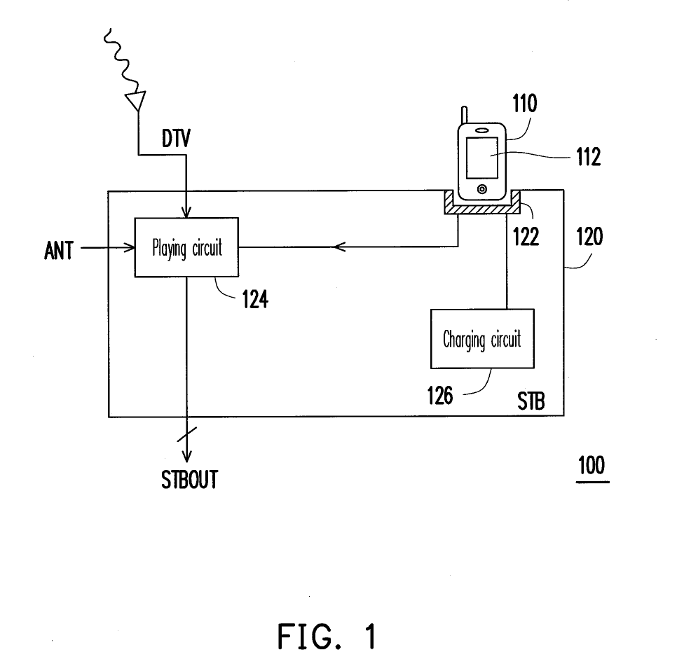

FIG. 1 is a diagram of a terrestrial/satellite STB system according to an embodiment of the invention. Referring to FIG. 1, a terrestrial/satellite STB system 100 includes a handheld device 110 and an STB 120. The handheld device 110 can be one of smart mobile phone, personal digital assistant (PDA) and portable digital multimedia player, for example, iPhone or Android phone. The handheld device 110 has a built-in interactive application program. The STB 120 is a receiving box of any broadcasting signal, cable terrestrial signal or satellite signal and can also play Internet protocol television (IPTV), wherein the cable terrestrial signal/satellite signal can, but not limited, include the signals of following standards or systems: Advanced Television Systems Committee (ATSC) of America standard, digital video broadcasting (DVB), digital video broadcasting-terrestrial (DVB-T), digital video broadcasting-handheld (DVB-H), digital video broadcasting-satellite (DVB-S), direct broadcast satellite (DBS), digital audio broadcasting (DAB), digital multimedia broadcasting (DMB), digital multimedia broadcast-terrestrial/handheld (DMB-TH), DirectTV and Dish Networks. The STB 120 can include a docking station 122 and a playing circuit 124.

The playing circuit 124 is coupled to the docking station 122, and the docking station 122 is for carrying the handheld device 110. The playing circuit 124 is for outputting an AV signal STBOUT to outside for playing the AV signal. When a user places the handheld device 110 into the docking station 122 of the STB 120 to start the interactive application program, the screen 112 of the handheld device 110 displays an interactive graphical user interface to guild the user for setting the STB 120.

The playing circuit 124 is coupled to the handheld device 110 via the docking station 122 and the playing circuit 124 can play the data transmitted from the handheld device 110. The handheld device 110 and the playing circuit 124 can perform bidirectional communications so as to delivery signals or messages.

When a user places the handheld device 110 into the docking station 122, the handheld device 110 can be linked to a wireless network and transfer the data from the wireless network to the STB 120 for playing. The handheld device 110 can be linked to a wireless network via 3G mobile communication protocol or global communication system protocol.

It should be noted that the STB 120 can further include a charging circuit 126 coupled to the docking station 122. When the handheld device 110 is placed into the docking station 122 of the STB 120, the charging circuit 126 can charge the handheld device 110, and the handheld device 110 can control the charging circuit 126 to charge the handheld device 110.

The STB 120 can further include an analog antenna port coupled to the playing circuit 124 for receiving an analog video signal ANT, and the playing circuit 124 then converts and plays the analog video signal ANT.

The STB 120 can further include a digital antenna port coupled to the playing circuit 124 for receiving a digital video signal DTV, and the playing circuit 124 then converts and plays the digital video signal DTV.

The STB 120 can further include an AV input port, an HD multimedia input port or a VGA input port, and the above-mentioned ports are coupled to the playing circuit 124. The playing circuit 124 converts and plays the signals from the above-mentioned ports.

The STB 120 can further include an image output port and an audio output port. The image output port is coupled to the output of the playing circuit 124 for outputting an image signal. The audio output port is coupled to the output of the playing circuit 124 for outputting an audio signal.

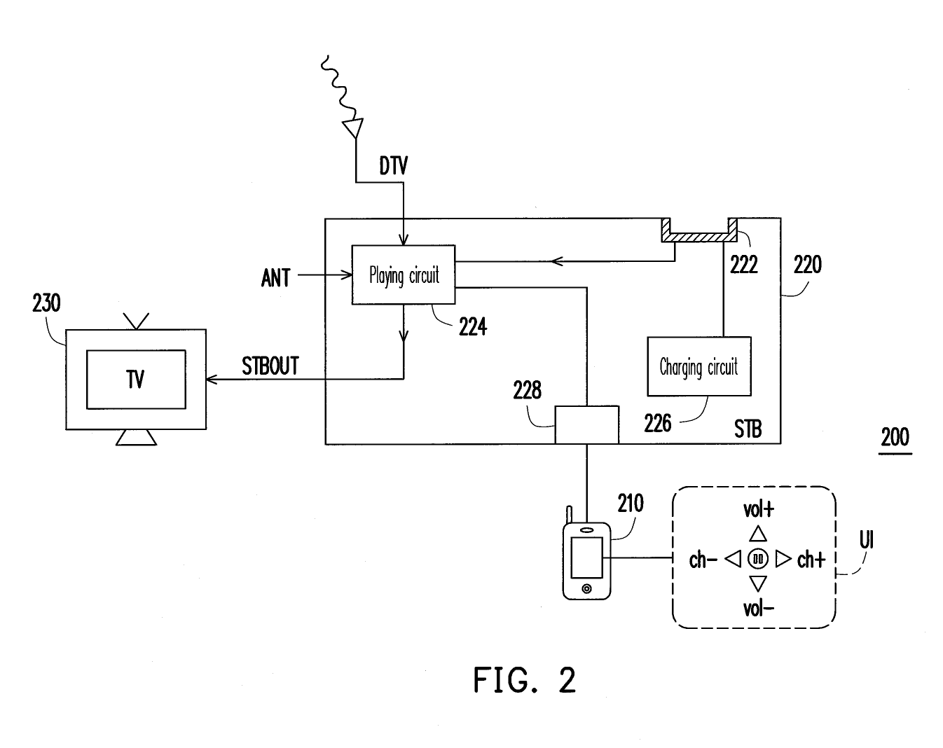

FIG. 2 is a diagram of a terrestrial/satellite STB system according to another embodiment of the invention. Referring to FIG. 2, a terrestrial/satellite STB system 200 can include a handheld device 210 and an STB 220. FIG. 2 is similar to the architecture of FIG. 1 except that the STB 220 further includes a communication receiver 228.

When a user uses the handheld device 210 to start an interactive application program, the handheld device 210 emits a control signal wirelessly transmitted to the communication receiver 228, the handheld device 210 or the display screen 230 (referring to the following) displays an interactive graphical user interface UI so as to guide the user for setting the STB 220. After starting the interactive application program, the handheld device 210 can serve as the remote controller of the STB 220.

The terrestrial/satellite STB system 200 can further include a display screen 230. The playing circuit 224 outputs a play menu to the display screen 230 for the user to conveniently set the STB 220, for example, setting source of played signal; setting channel management, including setting TV channel/sequence/group or deleting all TV channels and broadcasting channels; automatically searching for digital TV channel; setting terrestrial region, or setting a system default terrestrial value, for example, “Taiwan”. As a result, the user can utilize the handheld device 210 and use the handheld device 210 as a remote controller to set the sources of the played signals and TV channels of the STB 220. The interactive graphical user interface UI is showed in FIG. 2, wherein the user can use touching keys ch+ and ch− to add/delete channels and touching keys vol+ and vol− to adjust the audio volume.

It should be noted that the user can set any favourite channels on the handheld device 210, by which it is easier to find out often watching channels than using a common remote controller.

Moreover, the wireless transmission method between the handheld device 210 and the STB 220 can be one of infrared protocol, 3G mobile communication protocol and Wi-Fi protocol. The STB 220 can feed received information associated with the radio names, video, or electronic program guide back to the handheld device 210 via wireless transmission.

In addition, while the handheld device 210 serves as a remote controller, the handheld device 210 can be linked to a wireless network and transfer the data from the wireless network to the STB 220 for playing. The wireless transmission method between the handheld device 210 and the STB 220 can be one of infrared protocol, 3G mobile communication protocol, bluetooth protocol and Wi-Fi protocol.

As a result, the handheld device 210 can transmit the movies or photos therein to the STB 220 and then the STB 220 outputs the data to the display screen 230; or the handheld device 210 can be linked to a wireless network via 3G mobile communication protocol or global communication system protocol and transfer the YouTube movies or international news from the wireless network to the STB 220 for playing.

Although the above-mentioned embodiments have depicted several feasible implementations of the terrestrial/satellite STB system of the invention, but anyone skilled in the art should know that each manufacture has different design of a terrestrial/satellite STB system from each other, so that the applications of the invention are not limited to the above-mentioned implementations. In other words, whenever an STB has a docking station carrying a handheld device or has a handheld device able to remotely control the STB, the system has conformed to the spirit of the invention. More embodiments are depicted in follows so that anyone skilled in the art can further understand the spirit of the invention for implementing.

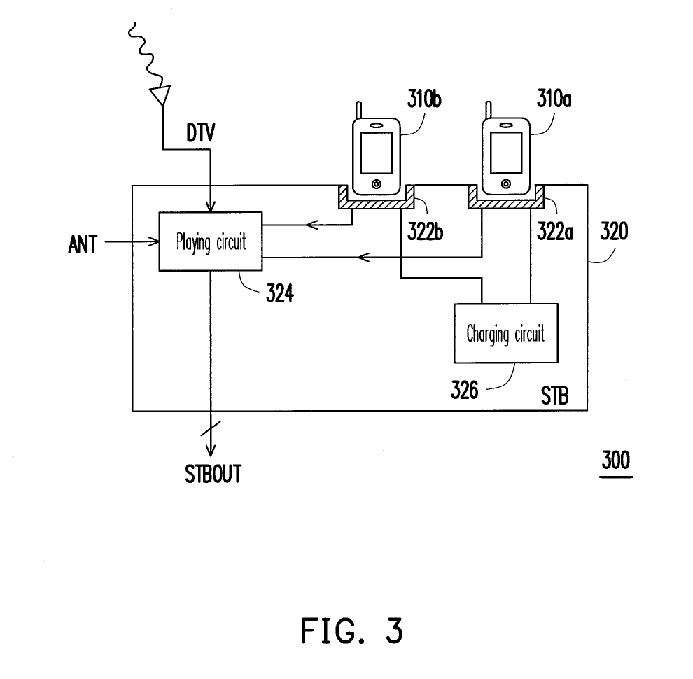

FIG. 3 is a diagram of a terrestrial/satellite STB system according to yet another embodiment of the invention. Referring to FIG. 3, a terrestrial/satellite STB system 300 can include two handheld devices 310a and 310b and an STB 320. The handheld devices 310a and 310b can respectively be one of smart mobile phone, PDA and portable digital multimedia player, for example, iPhone or Android phone. The STB 320 is a receiving box able to play any broadcasting signal, cable terrestrial signal or satellite signal, and to play Internet protocol television (IPTV), wherein the cable terrestrial signal/satellite signal can, but not limited, include the signals of following standards or systems: ATSC, DVB-T, DVB-H, DVB-S, DBS, DAB, DMB, DMB-TH, DirectTV and Dish Networks. The STB 320 can include two docking stations 322a and 322b and a playing circuit 324. The quantity of the docking stations of the STB 320 can be more, which the invention is not limited to. In the terrestrial/satellite STB system 300, when a user places the handheld device 310a into the docking station 322a of the STB 320 so as to start an interactive application program, the handheld device 310a displays an interactive graphical user interface for guiding the user to set the STB 320.

The playing circuit 324 can play the data transmitted from the handheld device 310a. When the handheld device 310b is placed into the docking station 322b of the STB 320, the playing circuit 324 can play the data transmitted from the handheld device 310b as well.

The STB 320 can further include a charging circuit 326 coupled to the docking stations 322a and 322b. When the handheld device 310a or 310n is placed into the docking station 322a or 322b of the STB 320, the charging circuit 326 charges the handheld device 310a or 310b. The handheld device 310a or 310b can control the charging circuit 326 so as to charge the handheld device 310a or 310b.

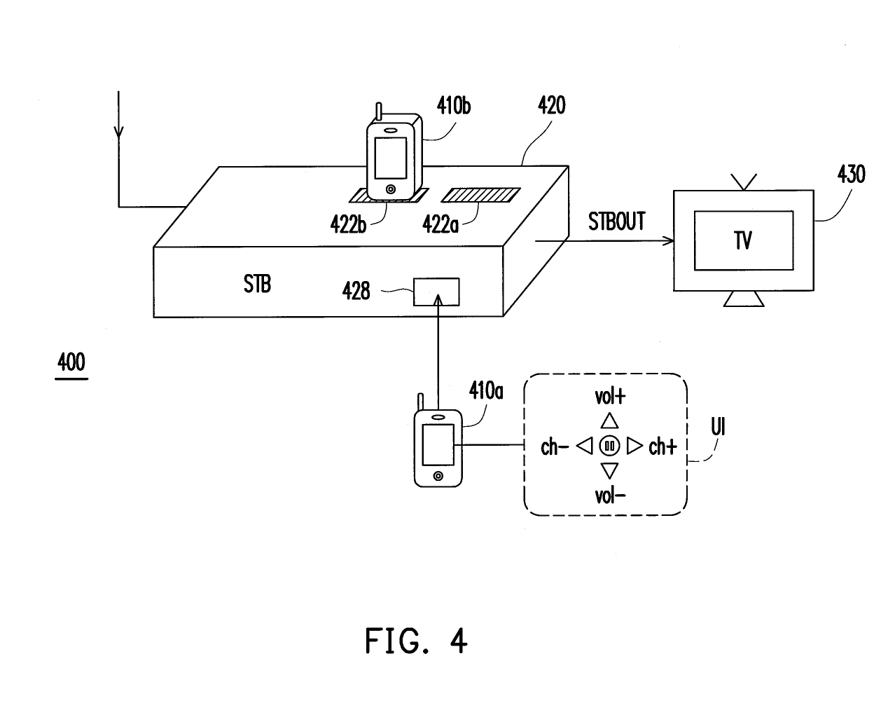

FIG. 4 is a diagram of a terrestrial/satellite STB system according to yet another embodiment of the invention. Referring to FIG. 4, a terrestrial/satellite STB system 400 is similar to the terrestrial/satellite STB system 200 of FIG. 2. The terrestrial/satellite STB system 400 can include two handheld devices 410a and 410b and an STB 420. The STB 420 includes two docking station 422a and 422b and a playing circuit (not shown, but can refer to FIG. 2).

The quantity of the docking station of the STB 420 can be more in association with the quantity of the handheld devices, which the invention is not limited to.

When a user uses the handheld device 410a to start an interactive application program, the handheld device 410a emits a control signal wirelessly transmitted to the communication receiver 428, and the handheld device 410a or the display screen 430 displays an interactive graphical user interface UI so as to guide the user for setting the STB 420. After starting the interactive application program, the handheld device 410a serves as the remote controller of the STB 420. The wireless transmission method between the handheld device 410a and the STB 420 can be one of infrared protocol, 3G mobile communication protocol, bluetooth protocol and Wi-Fi protocol. The STB 420 can feed received information associated with the radio names, video, or electronic program guide back to the handheld device 410a via wireless transmission.

When the handheld device 410b is placed into the docking station 422b of the STB 420, the playing circuit can play the data transmitted from the handheld device 410b. The handheld device 410b can be linked to a wireless network and transfer the data from the wireless network, such as YouTube movies or international news programs, to the STB 420 for playing. The handheld device 410b can be linked to the wireless network via 3G mobile communication protocol or global communication system protocol.

It should be noted that the handheld device 410b can transmit the movies or photos therein to the STB 420 and then the STB 420 outputs the data to the display screen 430; while the handheld device 410a serves as a remote controller, the handheld device 410a can be linked to a wireless network and transfer the data from the wireless network to the STB 420 for playing.

In summary, in the terrestrial/satellite STB system of the invention, since the STB has a docking station carrying the handheld device, the STB can be linked to a wireless network for playing movies, news, music and films from the network and the user does not need to pay the additional Internet fee for the STB. The STB of the invention not only provides the basic functions of a current STB, but also can charge the handheld device. The handheld device can provide the STB with remotely controlling function, so that the user can set favourite channels on the handheld device so as to increase the use convenience.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A terrestrial/satellite set-top-box system, comprising:
a handheld device, having a built-in interactive application program; and
a set-top-box, comprising:
a docking station, for carrying the handheld device; and
a playing circuit, coupled to the docking station for outputting an audio/video signal to outside for playing;
wherein the set-top-box is a receiving box of any broadcasting signal, cable terrestrial signal or satellite signal;
wherein when the handheld device is placed into the docking station of the set-top-box so as to start the interactive application program, the handheld device displays an interactive graphical user interface for guiding a user to set the set-top-box.

2. The terrestrial/satellite set-top-box system as claimed in claim 1, wherein the playing circuit is coupled to the handheld device via the docking station and the playing circuit plays the data transmitted from the handheld device.

3. The terrestrial/satellite set-top-box system as claimed in claim 1, wherein the handheld device is linked to a wireless network and transfers the data of the wireless network to the set-top-box for playing.

4. The terrestrial/satellite set-top-box system as claimed in claim 3, wherein the handheld device is linked to the wireless network via 3G mobile communication protocol or global communication system protocol.

5. The terrestrial/satellite set-top-box system as claimed in claim 1, wherein the set-top-box further comprises:
a charging circuit, coupled to the docking station, wherein when the handheld device is placed into the docking station of the set-top-box, the charging circuit charges the handheld device.

6. The terrestrial/satellite set-top-box system as claimed in claim 1, wherein the set-top-box further comprises:
an analog antenna port, coupled to the playing circuit for receiving an analog video signal, wherein the playing circuit is for converting and playing the analog video signal.

7. The terrestrial/satellite set-top-box system as claimed in claim 1, wherein the set-top-box further comprises:
a digital antenna port, coupled to the playing circuit for receiving a digital video signal, wherein the playing circuit is for converting and playing the digital video signal.

8. The terrestrial/satellite set-top-box system as claimed in claim 1, wherein the set-top-box further comprises an audio/video input port, a high-definition multimedia input port or a video graphics array input port, wherein the audio/video input port, the high-definition multimedia input port or the video graphics array input port is coupled to the playing circuit, and the playing circuit is for converting and playing the signals transmitted from the above-mentioned input ports.

9. The terrestrial/satellite set-top-box system as claimed in claim 1, wherein the set-top-box further comprises:
an image output port, coupled to the output of the playing circuit for outputting an image signal; and
an audio output port, coupled to the output of the playing circuit for outputting an audio signal.

10. The terrestrial/satellite set-top-box system as claimed in claim 1, wherein the handheld device is one of smart mobile phone, personal digital assistant and portable digital multimedia player.

11. A terrestrial/satellite set-top-box system, comprising:
a handheld device, having a built-in interactive application program; and
a set-top-box, comprising:
a docking station, for carrying the handheld device;
a communication receiver, for receiving the wireless command and data emitted from the handheld device; and
a playing circuit, coupled to the communication receiver and the docking station for outputting an audio/video signal to outside for playing;
wherein the set-top-box is a receiving box of any broadcasting signal, cable terrestrial signal or satellite signal;
wherein when a user uses the handheld device to start the interactive application program, the handheld device emits a control signal wirelessly transmitted to the communication receiver and the handheld device displays an interactive graphical user interface for guiding the user to set the set-top-box.

12. The terrestrial/satellite set-top-box system as claimed in claim 11, further comprising a display screen, wherein the playing circuit outputs a menu to the display screen for the user to set the set-top-box.

13. The terrestrial/satellite set-top-box system as claimed in claim 11, wherein after starting the interactive application program, the handheld device serves as a remote controller of the set-top-box.

14. The terrestrial/satellite set-top-box system as claimed in claim 13, wherein the handheld device is for setting source of a played signal, television channel and audio volume of the set-top-box.

15. The terrestrial/satellite set-top-box system as claimed in claim 11, wherein the wireless transmission method between the handheld device and the set-top-box is one of infrared protocol, 3G mobile communication protocol, bluetooth protocol and Wi-Fi protocol.

16. The terrestrial/satellite set-top-box system as claimed in claim 11, wherein the handheld device wirelessly transmits data to the set-top-box for playing.

17. The terrestrial/satellite set-top-box system as claimed in claim 16, wherein the set-top-box feeds received information associated with radio names, video, or electronic program guide back to the handheld device via wireless transmission.

18. The terrestrial/satellite set-top-box system as claimed in claim 11, wherein the handheld device is linked to a wireless network and transfers the data of the wireless network to the set-top-box for playing.

19. The terrestrial/satellite set-top-box system as claimed in claim 18, wherein the handheld device is linked to the wireless network via 3G mobile communication protocol or global communication system protocol.

20. The terrestrial/satellite set-top-box system as claimed in claim 11, wherein the set-top-box further comprises:
a charging circuit, coupled to the docking station, wherein when the handheld device is placed into the docking station of the set-top-box, the charging circuit charges the handheld device.

21. The terrestrial/satellite set-top-box system as claimed in claim 11, wherein the set-top-box further comprises:
an analog antenna port, coupled to the playing circuit for receiving an analog video signal, wherein the playing circuit is for converting and playing the analog video signal.

22. The terrestrial/satellite set-top-box system as claimed in claim 11, wherein the set-top-box further comprises:
a digital antenna port, coupled to the playing circuit for receiving a digital video signal, wherein the playing circuit is for converting and playing the digital video signal.

23. The terrestrial/satellite set-top-box system as claimed in claim 11, wherein the set-top-box further comprises an audio/video input port, a high-definition multimedia input port or a video graphics array input port, wherein the audio/video input port, the high-definition multimedia input port or the video graphics array input port is coupled to the playing circuit, and the playing circuit is for converting and playing the signals transmitted from the above-mentioned input ports.

24. The terrestrial/satellite set-top-box system as claimed in claim 11, wherein the set-top-box further comprises:
an image output port, coupled to the output of the playing circuit for outputting an image signal; and
an audio output port, coupled to the output of the playing circuit for outputting an audio signal.

25. A terrestrial/satellite set-top-box system, comprising:
a first handheld device, having a built-in interactive application program;
a second handheld device; and
a set-top-box, comprising:
a first docking station, for carrying the first handheld device;
a second docking station, for carrying the second handheld device; and
a playing circuit, coupled to the first docking station and the second docking station for outputting an audio/video signal to outside for playing;
wherein the set-top-box is a receiving box of any broadcasting signal, cable terrestrial signal or satellite signal;
wherein when the first handheld device is placed into the first docking station of the set-top-box so as to start the interactive application program, the first handheld device displays an interactive graphical user interface for guiding the user to set the set-top-box.

26. The terrestrial/satellite set-top-box system as claimed in claim 25, wherein the playing circuit is coupled to the first handheld device via the first docking station and the playing circuit plays the data transmitted from the first handheld device.

27. The terrestrial/satellite set-top-box system as claimed in claim 26, wherein the second handheld device is placed into the second docking station of the set-top-box, the playing circuit is coupled to the second handheld device via the second docking station and the playing circuit plays the data transmitted from the second handheld device.

28. A terrestrial/satellite set-top-box system, comprising:
a first handheld device, having a built-in interactive application program;
a second handheld device; and
a set-top-box, comprising:
a first docking station, for carrying the first handheld device;
a second docking station, for carrying the second handheld device;
a communication receiver, for receiving the wireless command and data emitted from the first handheld device; and
a playing circuit, coupled to the communication receiver, the first docking station and the second docking station for outputting an audio/video signal to outside for playing;
wherein the set-top-box is a receiving box of any broadcasting signal, cable terrestrial signal or satellite signal;
wherein when a user uses the first handheld device to start the interactive application program, the first handheld device emits a control signal wirelessly transmitted to the communication receiver and the first handheld device displays an interactive graphical user interface for guiding the user to set the set-top-box.

29. The terrestrial/satellite set-top-box system as claimed in claim 28, wherein after starting the interactive application program, the first handheld device serves as a remote controller of the set-top-box.

30. The terrestrial/satellite set-top-box system as claimed in claim 28, wherein the second handheld device is placed into the second docking station of the set-top-box, the playing circuit is coupled to the second handheld device via the second docking station and the playing circuit plays the data transmitted from the second handheld device.

31. The terrestrial/satellite set-top-box system as claimed in claim 30, wherein the second handheld device is linked to a wireless network and transfers the data of the wireless network to the set-top-box for playing.

32. The terrestrial/satellite set-top-box system as claimed in claim 31, wherein the second handheld device is linked to the wireless network via 3G mobile communication protocol or global communication system protocol.

33. The terrestrial/satellite set-top-box system as claimed in claim 28, wherein the first handheld device is for setting source of a played signal, television channel and audio volume of the set-top-box.

34. The terrestrial/satellite set-top-box system as claimed in claim 28, wherein the wireless transmission method between the first handheld device and the set-top-box is one of infrared protocol, 3G mobile communication protocol, bluetooth protocol and Wi-Fi protocol.

35. The terrestrial/satellite set-top-box system as claimed in claim 28, wherein the first handheld device wirelessly transmits data to the set-top-box for playing.

36. The terrestrial/satellite set-top-box system as claimed in claim 35, wherein the set-top-box feeds received information associated with radio names, video, or electronic program guide back to the first handheld device via wireless transmission.

37. The terrestrial/satellite set-top-box system as claimed in claim 28, wherein the first handheld device is linked to a wireless network and transfers the data of the wireless network to the set-top-box for playing.

38. The terrestrial/satellite set-top-box system as claimed in claim 37, wherein the first handheld device is linked to the wireless network via 3G mobile communication protocol or global communication system protocol.
